(19) United States
(12) Patent Application Publication
(10) Pub. No.: US 2025/0123132 A1
(43) Pub. Date: Apr. 17, 2025

(54) FLUID VELOCITY SENSOR UNIT AND/OR FLUID VOLUME FLOW RATE SENSOR UNIT AND DETERMINATION METHOD

(71) Applicant: SKF Lubrication Systems Germany GmbH, Walldorf (DE)

(72) Inventors: Joerg SCHWARTZ, Potsdam (DE); Peter HOPPE, Nordhorn (DE)

(21) Appl. No.: 18/694,628

(22) PCT Filed: Sep. 19, 2022
(86) PCT No.: PCT/EP2022/075930

§ 371 Date: Mar. 22, 2024

(30) Foreign Application Priority Data
Sep. 30, 2021 (DE) 10 2021 211 022.3

(51) Int. Cl. G01F 1/698; G01F 1/688; G01P 5/10

(52) U.S. Cl. CPC G01F 1/698; G01F 1/688; G01P 5/10

(57) ABSTRACT

A fluid velocity sensor unit (10) and/or fluid volume flow rate sensor unit has at least one heating element (12) which can be arranged in a fluid line (14). The heating element is formed at least by a part of a first transistor (16).

### CROSS-REFERENCE TO RELATED APPLICATIONS

The present application claims priority to PCT Application No. PCT/EP2022/075930, filed Sep. 19, 2022, and to German Application No. 102021211022.3, filed Sep. 30, 2021, the entireties of which are hereby incorporated by reference.

### FIELD

The present disclosure relates to fluid measurement, and in particular to a sensor for measuring velocity and/or volume flow rate of a fluid.

### BACKGROUND

It is known to measure a volume flow rate of fluids which are moving in a line.

Also known are thermoelectric anemometers. In this respect, in a hot-film anemometer or hot-wire anemometer, a sensor surface through which a flow takes place or a wire is used as a probe and is electrically heated. The materials used for the probe have a temperature-dependent resistance which increases as the temperature rises (PTC resistor). The electrically supplied thermal power is in part transported away by a flow as thermal power loss. As the flow velocity increases, the thermal loss also increases. The electrical power is therefore used as a measurable variable for determining the flow velocity. Two methods have become established for measuring the flow-induced thermal power loss: constant current anemometry (CCA) and constant temperature anemometry (CTA).

Also known for volume flow rate measurement is the principle of the constant temperature anemometer, in which an electrical heating element (PTC resistor) and a temperature-dependent measuring resistor are arranged at a defined distance from one another in the flow channel of a pipeline. The heating element consists of wire or of a metal film and is usually made of platinum. The heating element and the measuring resistor can be a chip component to which heating and measuring resistors have been applied by means of thick-film technology and thick-film methods. These precision components are expensive. An electronic controller ensures that a defined temperature difference between the heating resistor and the temperature-measuring resistor is maintained. Depending on the flow velocity, more or less energy has to be supplied to the heating element. The supplied energy is a measure of the volume flow rate in the pipeline. Alternative methods for measuring volume flow rate are, for example, mechanically operating oval wheel flow meters or methods based on ultrasound measurements.

### SUMMARY

The object of the present disclosure consists in particular in permitting an efficient fluid velocity measurement or fluid volume flow rate measurement. The object is achieved according to the present disclosure by the features of Patent claim 1 and by the features of Patent claim 10, while advantageous embodiments and developments of the present disclosure can be found in the dependent claims.

The present disclosure proceeds from a fluid velocity sensor unit and/or fluid volume flow rate sensor unit having at least one heating element which can be arranged in a fluid line.

It is proposed that the heating element is formed at least by a part of a first transistor. A “fluid velocity sensor unit” is to be understood in particular as being a unit which is able to determine at least one variable from which a fluid velocity can be determined, the unit preferably determining the fluid velocity. A “fluid volume flow rate sensor unit” is to be understood in particular as being a unit which is able to determine at least one variable from which a fluid volume flow rate can be determined, the unit preferably determining the fluid volume flow rate. A “fluid” is to be understood in particular as being at least one liquid and/or at least one gas. An efficient fluid velocity measurement or fluid volume flow rate measurement can thus be achieved. In particular, accurate measurement results can be achieved with an inexpensive design.

In particular, the heating element can be formed by a doped region of the transistor and/or by a npn structure of the transistor and/or by a pnp structure of the transistor.

Advantageously, the fluid velocity sensor unit or the fluid volume flow rate sensor unit has at least one circuit which comprises the first transistor and which is provided to keep a difference between a temperature of the first transistor and a reference temperature constant over time. “Provided” is to be understood as meaning in particular specially designed and/or specially equipped and/or specially programmed. A “temperature of a transistor” is to be understood in particular as being a temperature of a region of the transistor which is doped, the temperature preferably being a temperature of a barrier layer of the transistor. Measurements can thus be made possible at different times.

It is further proposed that the circuit comprises at least a second transistor which has a temperature which forms the reference temperature. An inexpensive design can thus be achieved.

In particular, the second transistor in an operating state can have a collector-emitter voltage which is less than approximately 0.6 volt. “Approximately 0.6 volt” is to be understood in particular as meaning a voltage which deviates from 0.6 V by less than 20%, preferably by less than 10% and particularly preferably by less than 3%. In this way, it can be achieved that the second transistor heats up relatively negligibly and can thus serve as the sensor.

Advantageously, the circuit comprises at least one amplifier which is provided to adjust a collector voltage of the first transistor such that a difference between the temperature of the first transistor and the reference temperature is constant over time. A “collector voltage of a transistor” is to be understood as meaning a voltage between a collector of the transistor and an emitter of the transistor. Conditions for the simple performance of a measurement can thus be created.

It is additionally proposed that the fluid velocity sensor unit or the fluid volume flow rate sensor unit comprises at least one control unit which is provided to ascertain at least one value of a collector voltage of the first transistor and, on the basis of the value of the collector voltage, to determine at least one value of a velocity of a fluid and/or at least one value of a volume flow rate of the fluid. A “control unit” is to be understood in particular as being a unit which comprises at least one processor, at least one memory and at least one operating program stored in the memory. A measurement can thus be achieved with a low outlay.

Advantageously, the control unit is provided to compare the ascertained value of the collector voltage with at least one value which is stored in the control unit, and to determine by the comparison at least a value of a fluid velocity and/or a value of a fluid volume flow rate. In this way, accurate results for the fluid velocity or for the fluid volume flow rate can be determined.

A device having a fluid velocity sensor unit or fluid volume flow rate sensor unit described hereinbefore is further proposed, said device having a fluid line, at least the first transistor being arranged in the fluid line. An efficient fluid velocity measurement or fluid volume flow rate measurement can thus be achieved.

Advantageously, a second transistor of a circuit of the fluid velocity sensor unit or of the fluid volume flow rate sensor unit is arranged upstream of, with respect to a flow direction of a fluid in the fluid line, and/or next to the first transistor. Heating of the second transistor by the first transistor can thus be avoided.

Advantageously, the device is provided to determine a quantity of fluid which has flowed through the fluid line. In this way, a large range of functions can be achieved in an inexpensive manner.

A method for determining a fluid velocity and/or for determining a fluid volume flow rate and/or for determining a quantity of fluid which has flowed is further proposed, in which method at least a part of a transistor is used as a heating element. An efficient fluid velocity measurement or fluid volume flow rate measurement can thus be achieved.

### BRIEF DESCRIPTION OF THE DRAWINGS

Further advantages will become apparent from the following description of the drawings. The drawings show an exemplary embodiment of the present disclosure. The drawings, the description and the claims contain numerous features in combination. A person skilled in the art will expediently also consider the features individually and combine them to form meaningful further combinations.

FIG. 1 shows a circuit of a fluid velocity sensor unit according to the present disclosure,

FIG. 2 shows a schematic axial section through a circuit board of the fluid velocity sensor unit in a fluid line,

FIG. 3 shows a collector voltage of a transistor of the fluid velocity sensor unit in dependence on time, and

FIG. 4 shows a schematic representation of the fluid velocity sensor unit.

### DETAILED DESCRIPTION

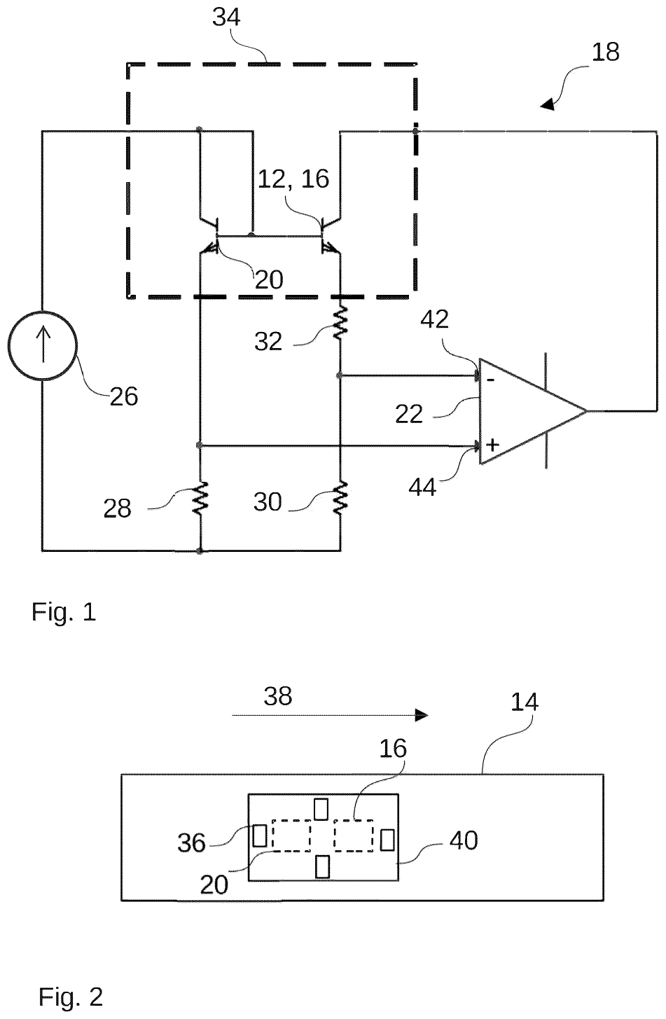

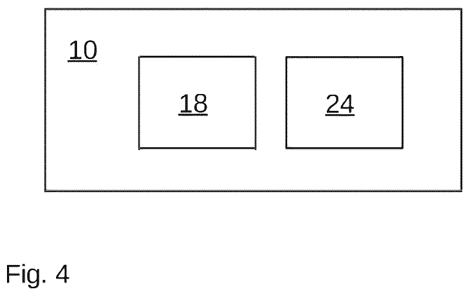

FIG. 1 shows a circuit 18 of a fluid velocity sensor unit 10 according to the present disclosure, which is illustrated schematically in FIG. 4. The fluid velocity sensor unit 10 is additionally a fluid volume flow rate sensor unit and has a heating element 12 which in an operating situation is arranged in a fluid line 14 (FIG. 2) and which is in the form of a first transistor 16. The circuit 18 comprises the transistor 16 and additionally a second transistor 20. In the present exemplary embodiment, both transistors 16, 20 are npn transistors. In addition, the transistors 16, 20 are of identical construction and exhibit NTC behaviour, that is to say negative temperature coefficient behaviour. A collector of the second transistor 20 is connected to a positive pole of a current source 26, which is in the form of a direct current source. The current source 26 is designed such that it always delivers a constant current. A negative pole of the current source is further connected via a resistor 28 to an emitter of the second transistor 20. A base of the second transistor 20 and a base of the first transistor 16 are likewise conductively connected to the positive pole of the current source 26. The negative pole of the current source 26 is connected via a resistor 30 and a resistor 32 to an emitter of the first transistor 16. The emitter of the second transistor 20 is conductively connected to a second input 44 of an amplifier 22 of the circuit 18. In addition, a line portion of the circuit 18 that connects the resistors 30 and 32 is conductively connected to a first input of the amplifier 22. An end of the resistor 32 which is remote from the resistor 30 is conductively connected to the emitter of the transistor 16. An end of the resistor 30 which is remote from the resistor 32 is conductively connected to the negative pole of the current source 26. An output of the amplifier is further conductively connected to a collector of the first transistor 16. In the operating state, a part 34 of the circuit 18 is arranged in the fluid line 14.

The circuit 18 is designed to keep a difference between a temperature of the doped region of the first transistor 16 and a reference temperature constant over time. The reference temperature is a temperature of the doped region of the second transistor 20. During operation, the amplifier 22 adjusts a collector voltage of the first transistor 16 such that the difference between the doped region of the first transistor 16 and the reference temperature is constant over time. During operation, the amplifier 22 behaves such that a voltage difference between its first input 42 and its second input 44 is always zero. Furthermore, the resistor 28 and the resistor 30 are the same size. In addition, the resistor 32 is very much smaller than the resistor 30.

The following applies for a collector current of a transistor when U_{BE} is significantly greater than U_{T}: approximately I_{C}=I_{S}×exp(U_{BE}/U_{T}), where I_{C} is the collector current, exp is the exponential function, I_{S} is an example-dependent saturation current and U_{BE} is the base-emitter voltage and U_{T}=k×T/e. In the latter equation, k is the Boltzmann constant and e is the elementary charge, wherein at room temperature U_{T}=25 mV. The temperature dependence of the base-emitter voltage in the case of silicon transistors is approximately −2 mV/K. The collector current is the current flowing between the collector and the emitter. It thus follows, by transformation, that U_{BE}=U_{T}×In(I_{C}/I_{S}), where In is the natural logarithm. Because the resistor 28 and the resistor 30 are the same, the collector currents of the transistors 16, 20 are the same, because the resistors 28, 30 serve to adjust the collector currents. Because the two transistors 16, 20 are of identical construction, their saturation currents are identical. If the difference between the base-emitter voltages of the two transistors is calculated, it is found that the difference between the temperature of the doped region of the transistor 20 and the temperature of the doped region of the transistor 16 can be determined from the difference between the base-emitter voltages of the two transistors 16, 20. The amplifier 22 acts on the circuit 18 by means of its output such that a potential difference between its inputs 42, 44 vanishes. The resistor 32 serves to set a constant difference between the mentioned temperatures of the transistors 16, 20. In the present exemplary embodiment, this difference is chosen as 10 K.

The transistor 20 serves as the sensor in the circuit 18 and is to heat up as little as possible. This is achieved in that the collector voltage of the transistor 20 is kept very low, for example at about 0.6 V. As already mentioned, the transistor 16 serves as a heater. Its collector receives a high voltage via the feedback output of the amplifier 22.

The fluid velocity sensor unit further comprises a control unit 24 (FIG. 4) which is provided and programmed to ascertain the value of the collector voltage of the first transistor 16 and the dependence thereof on time and, on the basis of the value of the collector voltage, to determine a value of a velocity of the fluid in the fluid line 14 and the dependence thereof on time and in addition a value of a volume flow rate of the fluid and the dependence thereof on time. If the control unit has determined a value of the collector voltage of the transistor 16, then the control unit compares that value with one or more values stored in the control unit. If the control unit ascertains that the determined value of the collector voltage lies between two adjacent values stored in the control unit, then the control unit determines for the determined value of the collector voltage a value of the fluid velocity and a value of the fluid volume flow rate by interpolation with the aid of the values of the collector voltage which are stored in the control unit, and values of the fluid velocity and of the fluid volume flow rate which are assigned to the collector voltage and which are likewise stored in the control unit. The stored values have been determined by other measuring instruments prior to the start of operation of the fluid velocity sensor unit.

In the fluid line 14 (FIG. 2), the first transistor 16 and the second transistor 20 are arranged adjacent to one another. More specifically, the part 34 is arranged on a circuit board 40 in the fluid line 14 such that the transistor 16 is arranged downstream of the transistor 20 with respect to a flow direction 38 of the fluid which is flowing in the fluid line 14. In addition to the transistors, the circuit board further has terminals 36.

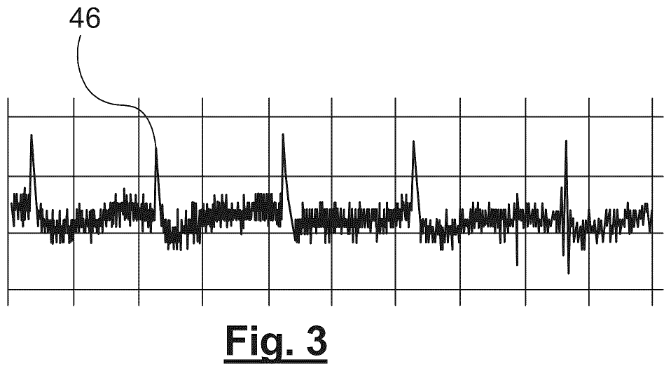

The fluid line 14, together with the fluid velocity sensor unit, forms a single device. The device is provided to determine a quantity of fluid which has flowed through the fluid line. The fluid is pumped through the fluid line 14 by a piston pump (not shown). A specific quantity of fluid is conveyed through the fluid line 14 by a piston stroke of the piston of the pump. FIG. 3 shows the collector voltage of the transistor 16 in dependence on time, as is determined by the control unit. The time is plotted on the abscissa and the collector voltage on the ordinate. The axes are linearly scaled. A piston stroke of the piston of the pump is illustrated by a peak 46. The control unit determines the quantity of fluid conveyed by a piston stroke by integrating the voltage with respect to time and further processing it by means of data already stored in the control unit. In this way, the control unit is able to determine the total quantity of fluid which flows through the fluid line 14 within a specific period of time.

The fluid can in particular be a lubricating oil and/or a lubricating grease. The fluid can in particular be liquid or gaseous. Furthermore, the quantity of fluid conveyed by a piston stroke can in particular be 3 mm³, 30 mm³, 60 mm³, 100 mm³, 0.8 cm³ or 100 cm³, for example. The fluid temperatures in operation can be 0° C., 25° C. or 40° C., for example, or another temperature which appears expedient to a person skilled in the art. The peak 46 can in particular lie between approximately 30 mV and approximately 255 mV, for example.

In the described method for determining the fluid velocity, the fluid volume flow rate and the quantity of fluid that has flowed, the doped region of the transistor 16 is used as the heating element. The temperature of the heating element is higher than the temperature of the fluid. The flowing fluid thus tries to cool the heating element. For this reason, the energy which must be supplied to the heating element per unit time in order for its temperature to remain constant can be used as a measure of the speed of the flowing fluid.

In an alternative embodiment of the present disclosure, the value of the resistor 28 is a sum of the value of the resistor 30 and the value of the resistor 32.

Because no expensive precision components are required in the circuit 18, it can be produced very inexpensively.

List of reference signs:

| | |
|---|---|
| 10 | Fluid velocity sensor unit |
| 12 | Heating element |
| 14 | Fluid line |
| 16 | Transistor |
| 18 | Circuit |
| 20 | Transistor |
| 22 | Amplifier |
| 24 | Control unit |
| 26 | Current source |
| 28 | Resistor |
| 30 | Resistor |
| 32 | Resistor |
| 34 | Part |
| 36 | Terminal |
| 38 | Flow direction |
| 40 | Circuit board |
| 42 | Input |
| 44 | Input |
| 46 | Peak |

1. A fluid velocity sensor unit and/or fluid volume flow rate sensor unit comprising:
at least one heating element configured to be arranged in a fluid line, the heating element being formed at least by a part of a first transistor.

2. The fluid velocity sensor unit and/or fluid volume flow rate sensor unit according to claim 1, further comprising
at least one circuit which comprises the first transistor and which is provided to keep a difference between a temperature of the first transistor and a reference temperature constant over time.

3. The fluid velocity sensor unit and/or fluid volume flow rate sensor unit according to claim 2, wherein
the circuit comprises at least a second transistor which has a temperature which forms the reference temperature.

4. The fluid velocity sensor unit and/or fluid volume flow rate sensor unit according to claim 2, wherein
the circuit comprises at least one amplifier which is provided to adjust a collector voltage of the first transistor such that a difference between the temperature of the first transistor and the reference temperature is constant over time.

5. The fluid velocity sensor unit and/or fluid volume flow rate sensor unit according to claim 2, further comprising
at least one control unit which is provided to ascertain at least one value of a collector voltage of the first transistor and, on the basis of the value of the collector voltage, to determine at least one value of a velocity of a fluid and/or at least one value of a volume flow rate of the fluid.

6. The fluid velocity sensor unit and/or fluid volume flow rate sensor unit according to claim 5, wherein
the control unit is provided to compare the ascertained value of the collector voltage with at least one value which is stored in the control unit, and to determine by the comparison at least a value of a fluid velocity and/or a value of a fluid volume flow rate.

7. A device having a fluid velocity sensor unit and/or a fluid volume flow rate sensor unit according to claim 1, the device including
the fluid line, in which at least the first transistor is arranged.

8. The device according to claim 7, wherein the fluid velocity sensor unit and/or the fluid volume flow rate sensor unit includes a circuit with a second transistor, wherein
the second transistor of the circuit is arranged upstream of, with respect to a flow direction of a fluid in the fluid line, and/or next to the first transistor.

9. The device according to claim 7, wherein
the device is provided to determine a quantity of fluid which has flowed through the fluid line.

10. A method for determining a fluid velocity and/or for determining a fluid volume flow rate and/or for determining a quantity of fluid which has flowed, in which at least a part of a transistor is used as a heating element.

11. The fluid velocity sensor unit and/or fluid volume flow rate sensor unit according to claim 3, wherein the circuit comprises at least one amplifier which is provided to adjust a collector voltage of the first transistor such that a difference between the temperature of the first transistor and the reference temperature is constant over time.

12. The fluid velocity sensor unit and/or fluid volume flow rate sensor unit according to claim 11, further comprising at least one control unit which is provided to ascertain at least one value of a collector voltage of the first transistor and, on the basis of the value of the collector voltage, to determine at least one value of a velocity of a fluid and/or at least one value of a volume flow rate of the fluid.

13. The fluid velocity sensor unit and/or fluid volume flow rate sensor unit according to claim 12, wherein the control unit is provided to compare the ascertained value of the collector voltage with at least one value which is stored in the control unit, and to determine by the comparison at least a value of a fluid velocity and/or a value of a fluid volume flow rate.

14. A device having a fluid velocity sensor unit and/or a fluid volume flow rate sensor unit according to claim 13, the device including the fluid line, in which at least the first transistor is arranged.

15. The device according to claim 14, wherein the fluid velocity sensor unit and/or the fluid volume flow rate sensor unit includes a circuit with a second transistor, wherein the second transistor of the circuit is arranged upstream of, with respect to a flow direction of a fluid in the fluid line, and/or next to the first transistor.

16. The device according to claim 15, wherein the device is provided to determine a quantity of fluid which has flowed through the fluid line.
